(19) United States
(12) Patent Application Publication
(10) Pub. No.: US 2026/0249523 A1
(43) Pub. Date: Aug. 27, 2026

(54) FURNITURE WITH SURFACE TEXTURE

(71) Applicant: Correctional Technologies, Inc., Willowbrook, IL (US)

(72) Inventor: Joseph R. Claffy, Western Springs, IL (US)

(21) Appl. No.: 19/549,325

(22) Filed: Feb. 25, 2026

Related U.S. Application Data
(60) Provisional application No. 63/954,748, filed on Jan. 6, 2026.
(60) Provisional application No. 63/763,082, filed on Feb. 25, 2025.

(51) Int. Cl. B29C 41/04; A47B 96/20; A47C 19/02; B29C 33/42; B29C 41/38; B29L 31/44

(52) U.S. Cl. CPC B29C 41/042; A47B 96/20; A47C 19/021; B29C 33/424; B29C 41/38; A47B 2220/0052; B29K 2023/06; B29K 2905/00; B29L 2031/44

(57) ABSTRACT

In one aspect, a method is provided for making rotationally molded furniture with a texture, such as a woodgrain texture. The method includes rotationally molding furniture using a mold having the woodgrain texture and removing the rotationally molded furniture from the mold, the rotationally molded furniture having the woodgrain texture. The method further includes applying a colorant to the woodgrain texture of the rotationally molded furniture and removing colorant from a portion of the woodgrain texture of the rotationally molded furniture.

### CROSS REFERENCE TO RELATED APPLICATIONS

This application claims the benefit of U.S. provisional patent application number 63/763,082, filed February 25, 2025, and U.S. provisional patent application number 63/954,748, filed January 6, 2026, which are all hereby incorporated by reference in their entireties.

### TECHNICAL FIELD

This disclosure relates generally to rotationally molded furniture and, more specifically, relates to rotationally molded furniture having surfaces with texture.

### BACKGROUND

Correctional, mental health, and behavioral health facilities often have furniture that is designed to limit the ability of an individual to hurt themselves or others using the furniture. One issue with conventional furniture for these types of facilities is that the furniture has an appearance that is different than typical furniture found in a home or other residence. Thus, conventional furniture for correctional, mental health, and behavioral health facilities may be off-putting for some individuals in these facilities.

### BRIEF DESCRIPTION OF DRAWINGS

FIG. 1 is a perspective view of a bed having a surface texture;

FIG. 2A is a side elevational view of the bed of FIG. 1 showing panels of a side wall of the bed;

FIG. 2B is a side elevational view similar to FIG. 2A showing different woodgrain textures of different portions of the side wall;

FIG. 2C is a view of the different woodgrain textures of FIG. 2B exploded to better illustrate the different woodgrain textures of the different portions of the side wall;

FIG. 3 is a top plan view of the bed of FIG. 1 showing a bedpan of the bed;

FIG. 4 is a bottom plan view of the bed of FIG. 1 showing knockout doors and a compartment formed in a bottom surface of the bed;

FIG. 5 is an end elevational view of the bed of FIG. 1 showing panels of an end wall of the bed;

FIG. 6 is a cross-sectional view taken along line 6-6 in FIG. 5 showing an angular cross-sectional shape of a post of the bed;

FIG. 7 is a cross-sectional view taken along line 7-7 in FIG. 3 showing a hollow interior of the bed;

FIG. 8 is a cross-sectional view taken along line 8-8 in FIG. 3 showing recesses for receiving mounts at corners of the bed;

FIG. 9 is a perspective view of a mount to be received in one of the recesses of FIG. 8;

FIG. 10 is an enlarged view of the area shown in a dashed circle in FIG. 8 showing the mount of FIG. 9 received in the recess of the bed;

FIG. 11 is a flow diagram of a method of manufacturing furniture having a surface texture;

FIGS. 12-16 are schematic views of a method of forming the furniture with surface texture according to the method of FIG. 11;

FIGS. 17 and 18 are perspective views of a cabinet having a surface texture;

FIG. 19 is a perspective view of another cabinet having a surface texture; and

FIG. 20 is a perspective view of a nightstand having a surface texture.

### DETAILED DESCRIPTION

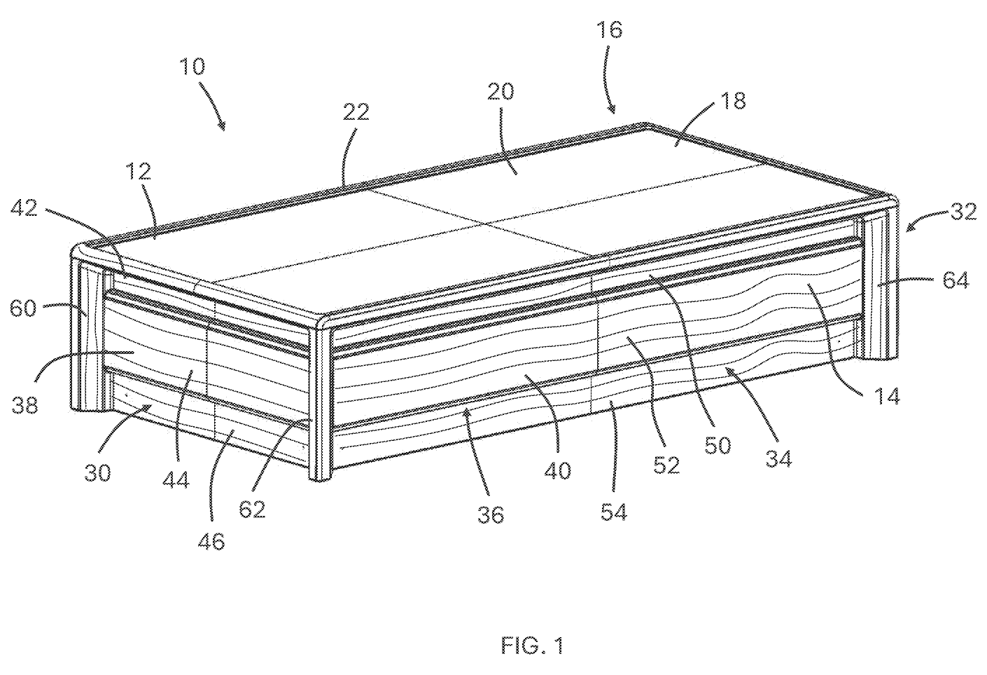

Regarding FIG. 1, a bed 10 is provided that has a body 12 formed using rotational molding and has a unitary, one-piece construction. In one embodiment, the body 12 is rotationally molded with high-impact polyethylene. The body 12 is hollow or may contain a structural foam in one embodiment. The body 12 has one or more exposed outer surfaces 14 with a woodgrain texture. The outer surfaces 14 are also ligature resistant. More specifically, the outer surfaces 14 of the bed 10 accessible by a patient lack sharp corners, sharp edges, through openings, or outer structures that a patient could use to do injure themselves with. For example, the outer surfaces 14 lack features that a cord, rope, or other material can be tied around or leveraged by a patient to injure themselves.

The bed 10 has a mattress support portion 16 with a bedpan 18 that includes an upper wall 20 and peripheral ridges 22 to support a mattress on the bedpan 18. The bedpan 18 may have a smooth finish to promote cleanability of the bedpan 18, for example, to enable cleaning of urine, bedbugs, or bacteria such as MRSA from the bedpan 18.

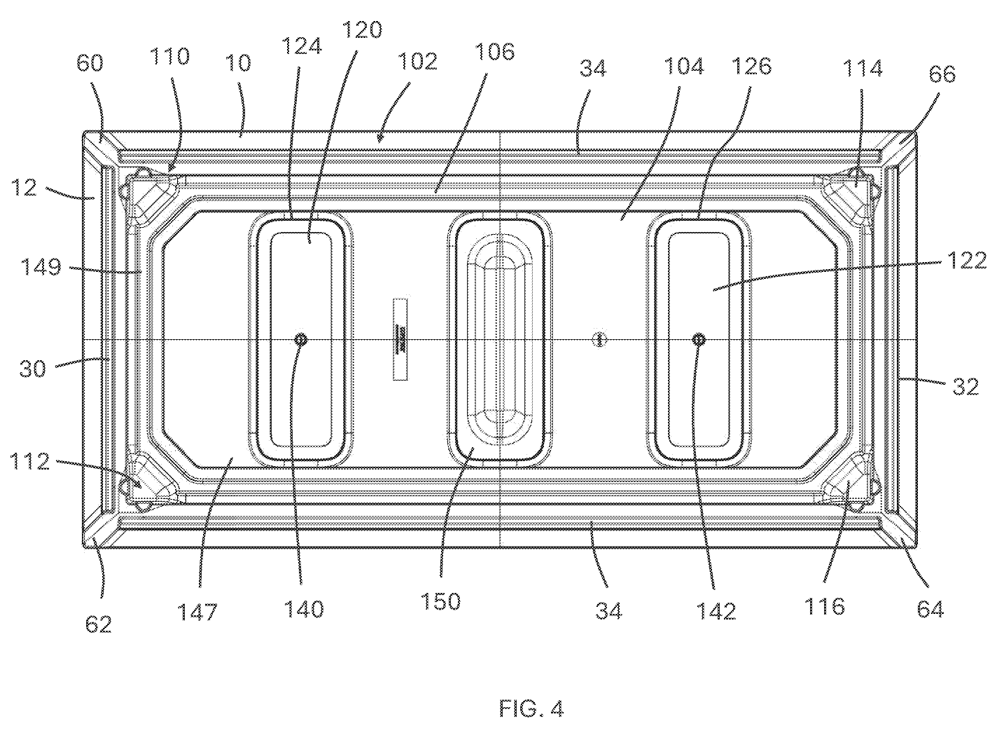

The body 12 has a footboard end wall 30, a headboard end wall 32, and side walls 34 extending therebetween. The footboard end wall 30, headboard end wall 32, and side walls 34 have strengthening features 36 including side panels 38, 40 configured to resist deflection of the walls 30, 32, 34. For example, the side panels 38 of the footboard end wall 30 include an upper panel 42, intermediate panel 44, and a kick panel 46. Similarly, the side panels 40 of the side walls 34 include an upper panel 50, intermediate panel 52, and a kick panel 54. The body 12 has posts 60, 62, 64, 66 (see FIG. 4) connecting the footboard end wall 30, the headboard end wall 32, and the side walls 34.

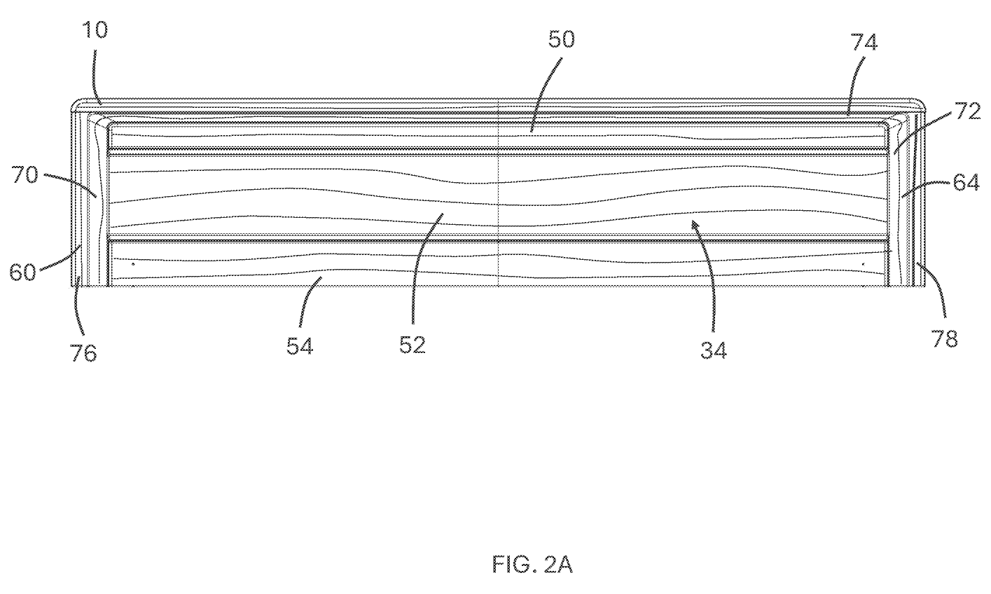

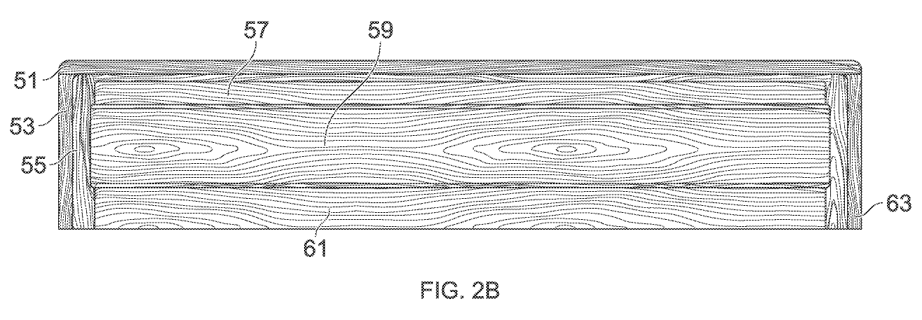

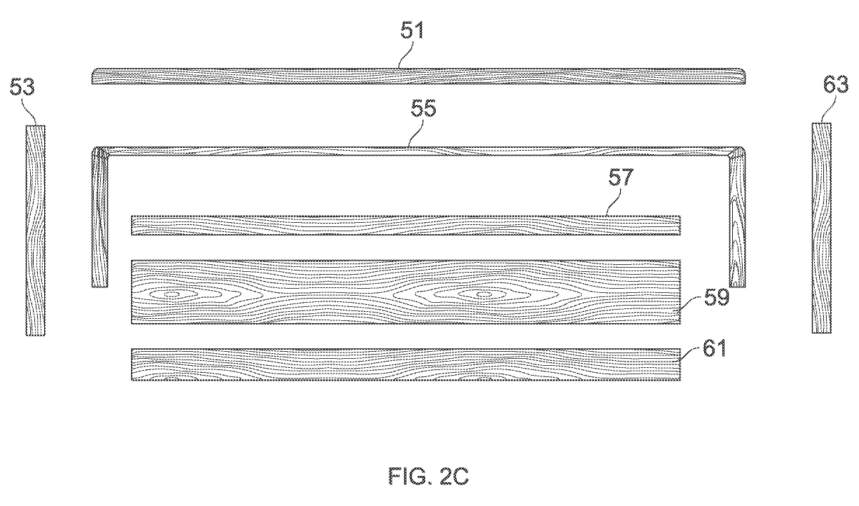

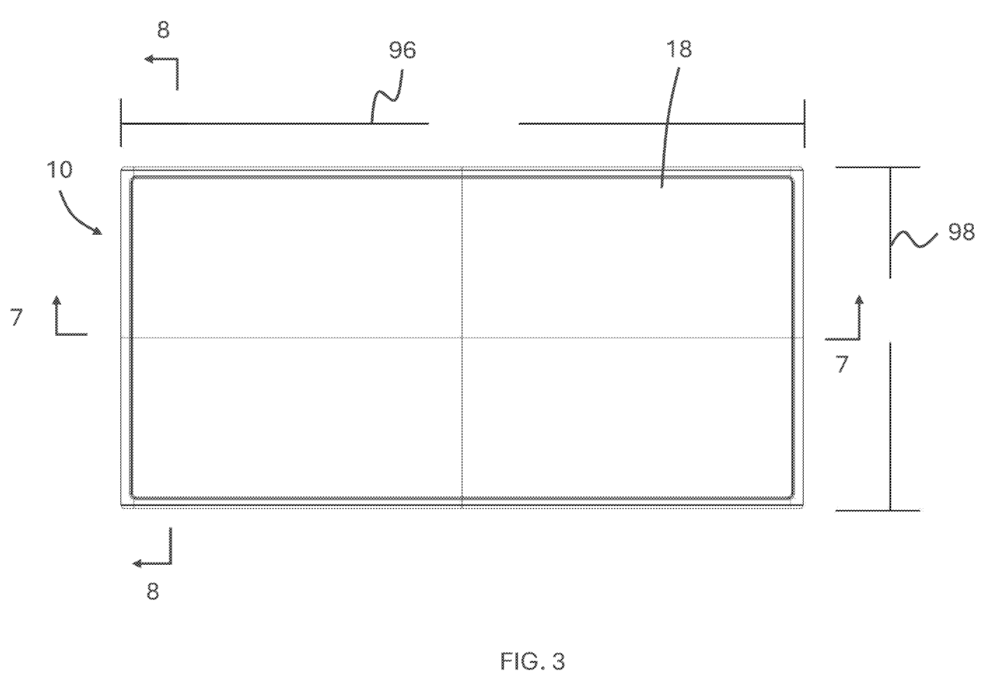

Regarding FIG. 2A, the posts 60, 64 have tapered portions 70, 72 that lead into a recess 74 of the strengthening feature 36. The upper, intermediate, and kick panels 50, 52, 54 are inset or recessed (into the page) from laterally outer walls 76, 78 of the posts 60, 64. The varying insets of the panels 50, 52, 54 creates a structured cross-section (taken perpendicular to a length 96 of the bed 10, see FIG. 3) of each of the side walls 34 which strengthens the side walls 34.

FIGS. 2B-2C show an example arrangement of woodgrain patterns. Each side wall 34 has exterior surface portions 51, 53, 55, 57, 59, 61, 63 with varying woodgrain textures. For example, portions 51, 57 have a generally horizontally oriented grain whereas portions 53, 63 have generally vertically oriented textures. As another example, the portions 51, 53, 63 have generally straight grains whereas portions 59, 61 have grains arranged in rings. As yet another example, the portions 53, 63 have darker colors in their woodgrain textures whereas portions 55, 57 have lighter colors in their woodgrain textures. The different sizes, shapes, orientations, and colors of the woodgrain of the exterior surface portions 51, 63 provide the side wall 34 with the visual appearance of being formed from assembled pieces of wood. The footboard end wall 30 and headboard end wall 32 each have a similar collection of exterior surface portions with varying woodgrain textures to provide the footboard end wall 30 and headboard end wall 32 with the visual appearance of being formed from assembled pieces of wood.

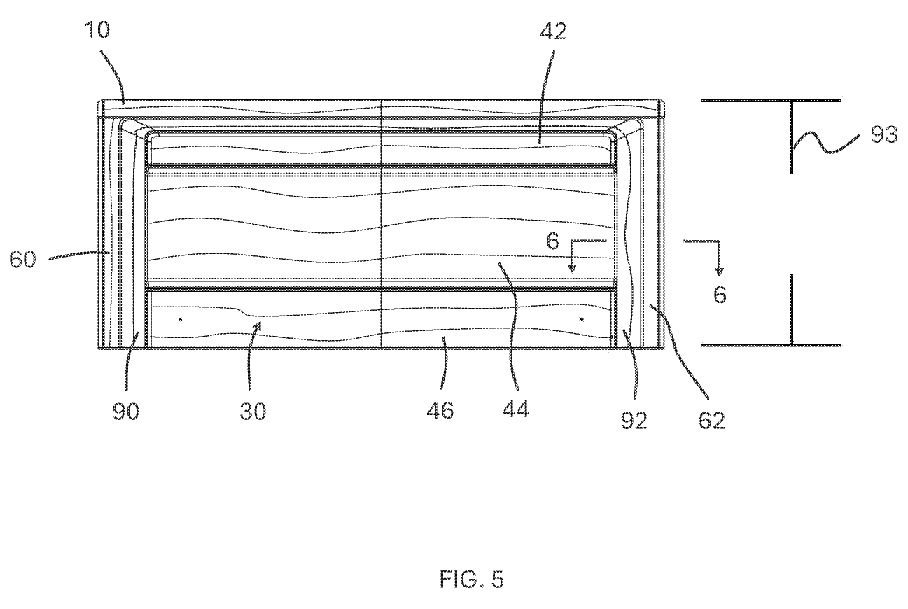

Regarding FIG. 5, the footboard end wall 30 likewise has the upper, intermediate, kick panels 42, 44, 46 bounded by tapered wall portions 90, 92 of the posts 60, 62. The panels 42, 44, 46 are at varying insets from one another to create a structured cross-section (taken perpendicular to a width 98 of the bed 10, see FIG. 3) and strengthen the footboard end wall 20. The headboard end wall 32 has a similar construction as the footboard end wall 30.

With reference to FIGS. 3 and 5, the bed 10 has a height 93 selected to position the mattress a desired distance above the floor. Further, the length 96 and width 98 of the bed 10 are selected to size the bedpan 18 to receive a particular mattress.

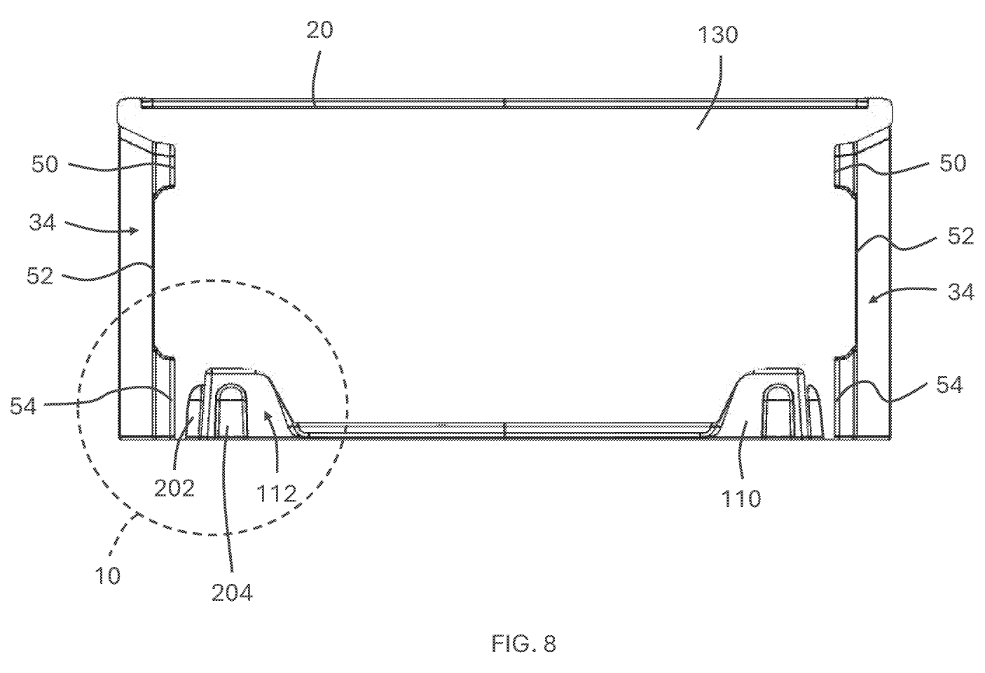

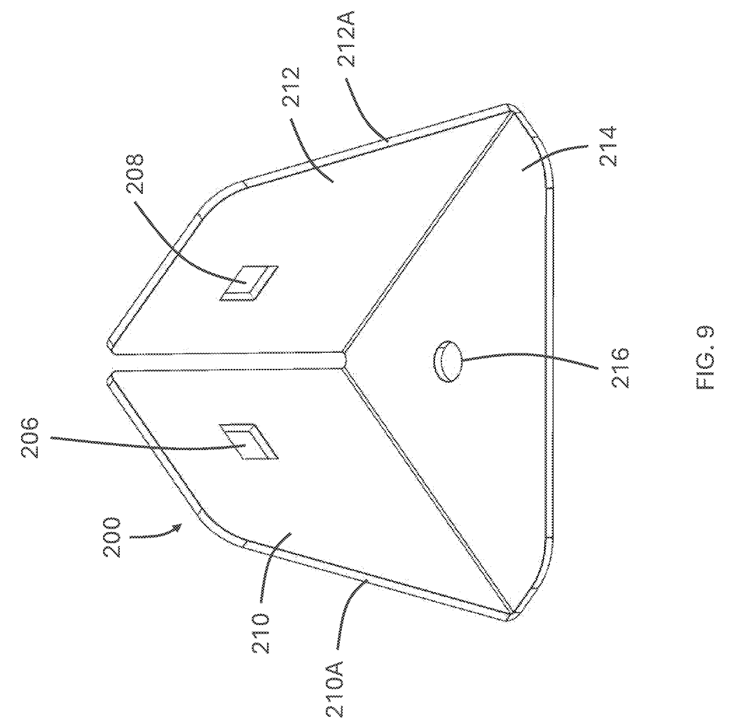

Regarding FIG. 4, the bed 10 has a plinth or base 102 with a bottom wall 104 for resting upon a floor of a facility. The bottom wall 104 includes a channel 106 extending about the base 102 to strengthen the bed 10. The bed 10 has recesses 110, 112, 114, 116 for receiving mounts 200 (see FIG. 9) to connect the body 12 of the bed 10 to the floor.

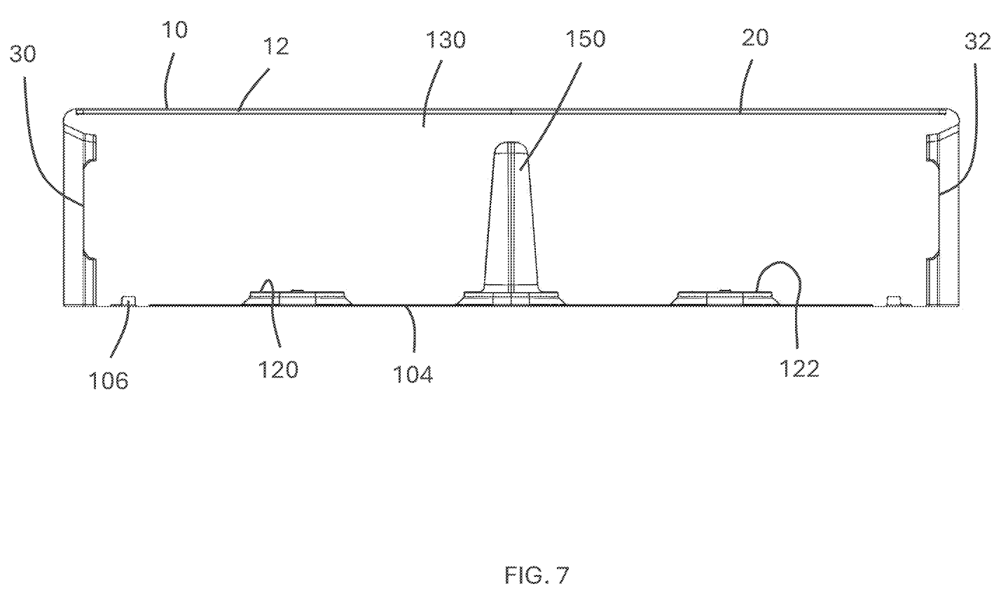

In addition to or instead of the mounts 200, an installer may secure the bed 10 to the floor of a facility by positioning sandbags or other weights in a void or an interior 130 (see FIG. 7) of the body 12. More specifically, the bottom wall 104 has ballast doors 120, 122 that may be knocked out or otherwise removed to form openings 124, 126 that provide access to the interior 130 of the body 12. Sandbags or other weights may be positioned in the interior 130 via the openings 124, 126 to resist movement of the bed 10 once the bed 10 has been installed in a facility. The bed 10 includes tamperproof hardware (e.g. fasteners and/or retaining clips) to secure the ballast doors 120, 122 in place.

The knockout doors 120, 122, or another portion of the bottom wall 104, have mold vent holes 140, 142 that facilitate the release of pressure during the rotational molding of the body 12. The mold vent holes 140, 142 are closed by caps or other closure members that are adhered or ultrasonically welded to the body 12 to cover the openings. The body 12 further includes a compartment 150 that extends from the bottom wall 104 into the interior 130 of the body 12 as shown in FIG. 7.

The different surfaces of the bed 10 may have different surface finishes. For example, the footboard end wall 30, a headboard end wall 32, and side walls 34 may have a woodgrain texture while the bottom surface of the bed 10 have smoother surfaces. For example, regarding FIG. 4, the inner surfaces of the compartment 150 may have a mirror polish, a bottom surface 147 of the bottom wall 104 may have a sandblasted finish, and surfaces 149 of the channel 106 may be a sanded finish. The finishes of the smooth surfaces (e.g., inner surfaces of compartment 150, bottom surface 147, and surfaces 149) are imparted by the mold used to form the bed 10.

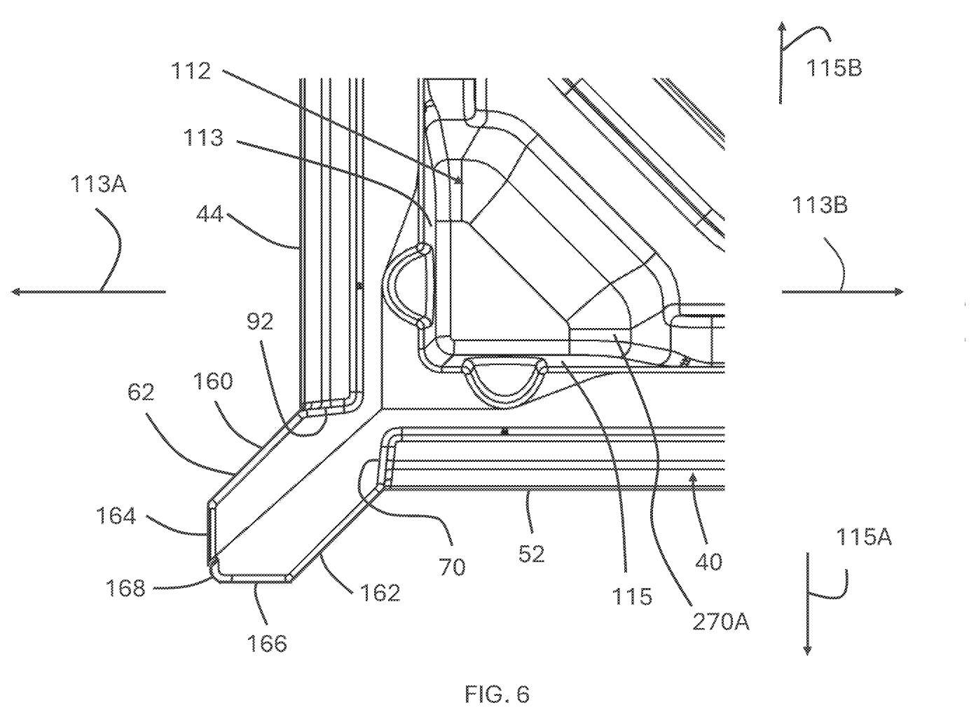

Regarding FIG. 6, the post 62 has an angular construction including parallel post side walls 160, 162, inclined post end walls 164, 166, and a juncture 168 connecting the post end walls 164, 166. The angular construction of the post 62 provides rigidity for the body 12. Further, the angular construction of the post 62 provide a visual appearance that resembles an assembled residential bed with the side panels 38, 40 being assembled with the post 62. The posts 60, 64, 66 have a similar construction as the post 62.

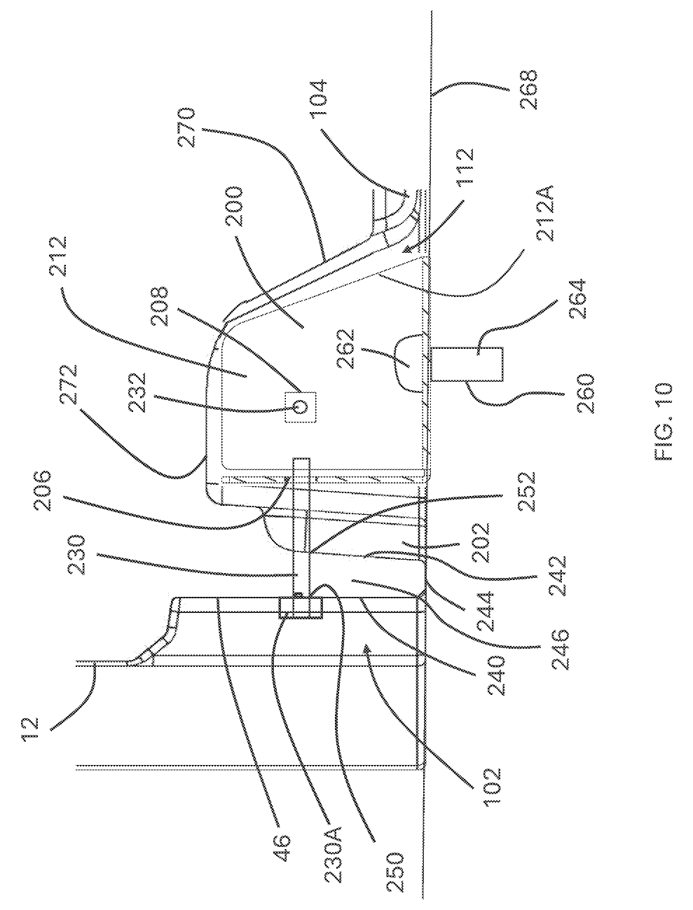

Regarding FIG. 8, the recess 112 will be discussed in greater detail below although the recesses 110, 114, 116 are similar. The recess 112 is configured to receive a mount 200 (see FIG. 9) and has grooves 202, 204 to receive fasteners that extend through openings 206, 208 in wall portions 210, 212 of the mount 200. The mount 200 further includes a plate portion 214 with an opening 216 to receive an anchor 260 (see FIG. 10) to secure the body 12 to the floor.

Regarding FIG. 10, the recess 112 is shown receiving the mount 200 with screws 230, 232 connecting the mount 200 to the body 12. More specifically, the base 102 includes an outer wall portion 240 of the kick panel 46, inner wall portion 242, a bottom wall portion 244, and a spacing 246 between the outer and inner wall portions 240, 242. The screw 230 extends through openings 250, 252 that are formed in the outer and inner wall portions 240, 242. The screw 230 extends into the opening 206 while the screw 232 extends through the opening 208 of the mount 200. The screws 230, 232 have head portions 230A outside of the outer wall portion 240 that may be painted or covered to blend into the appearance of the outer wall portion 240. The anchor 260 has a head 262 seated against the plate portion 214 of the mount 200 and a shank portion 264 extending through the opening 216 and into the floor 268. In one embodiment, the anchor 260 is a concrete expansion anchor. Because the screws 230, 232 extend through the openings 206, 208 of the mount 200, the contact between the screws 230, 232 and mount 200 inhibits lifting the body 12 vertically away from the floor 268. Further, contact between the wall portions 210, 212 of the mount 200 and wall portions 113, 115 (see FIG. 6) resists horizontal movement of the body 12 along the floor in directions 113A, 115A. The mounts 200 received in the other recesses 110, 114, 116 likewise resist vertical and horizontal movement of the body 12 and keep the body 12 secured to the floor 268.

With reference to FIG. 10, the body 12 has a lower tapered wall portion 270 and an upper wall portion 272 of the recess 112. As the body 12 is lowered onto the mount 200, the tapered wall portion 270 may contact a tapered edge 212A of the mount wall portion 212. The contact between the tapered wall portion 270 of the body 12 and the tapered edge 212A of the mount 200 centers the recess 112 on the mount 200 in lateral or left/right directions 115A, 115B (see FIG. 6). The recess 112 has a similar, tapered wall portion 270A (see FIG. 6) to contact a tapered edge 210A (see FIG. 9) of the mount wall portion 210 and likewise center the recess 112 on the mount in longitudinal or fore/aft directions 113A, 113B (see FIG. 6).

In one approach, the mounts 200 are first secured to the floor 268 at the desired location of the bed 10 on the floor 268. Subsequently, the recesses 110, 112, 114, 116 are aligned with the mounts 200 and the body 12 is lowered onto the mounts 200. Next, the screws 230, 232 are driven into the body 12 to form the openings 250, 252 (see FIG. 10) and extend into the openings 206, 208 of the mounts 200 to secure the body 12 to the mounts 200. The screws 230, 232 may be tamper-proof.

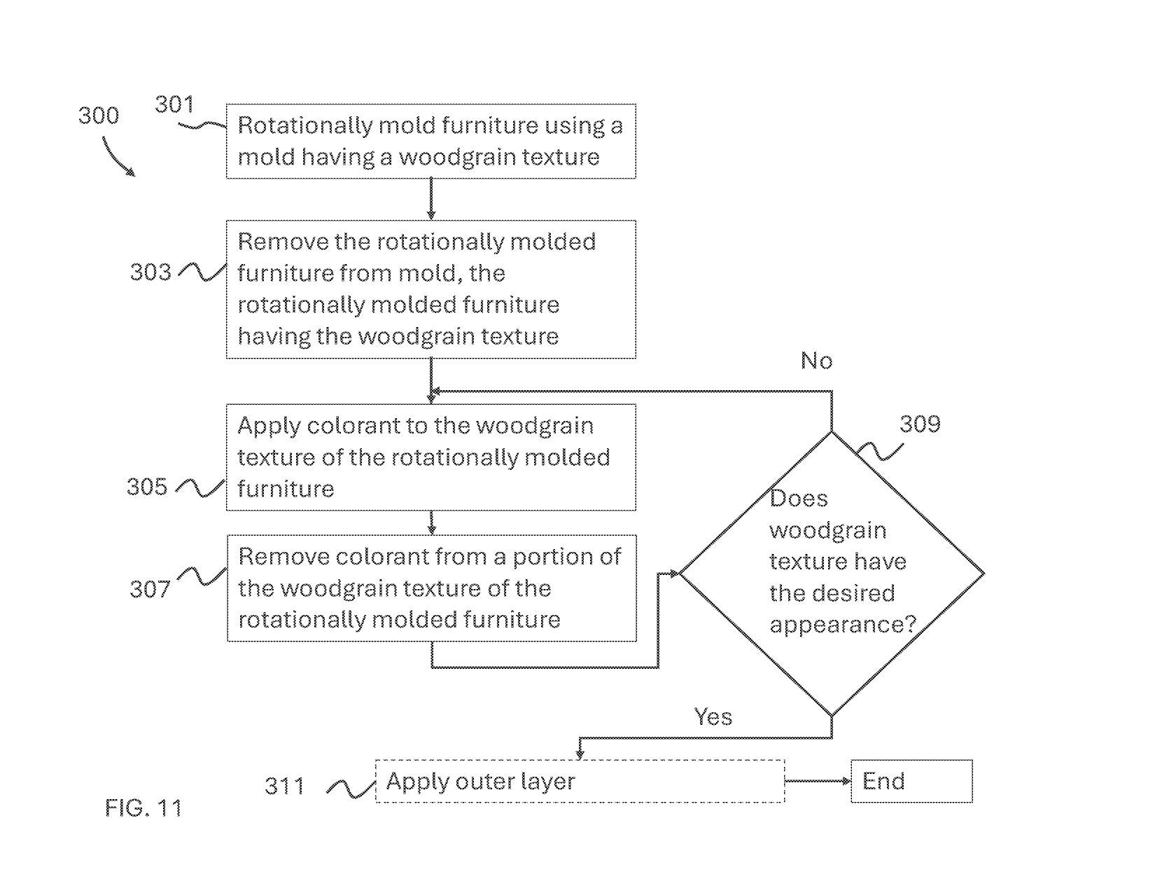

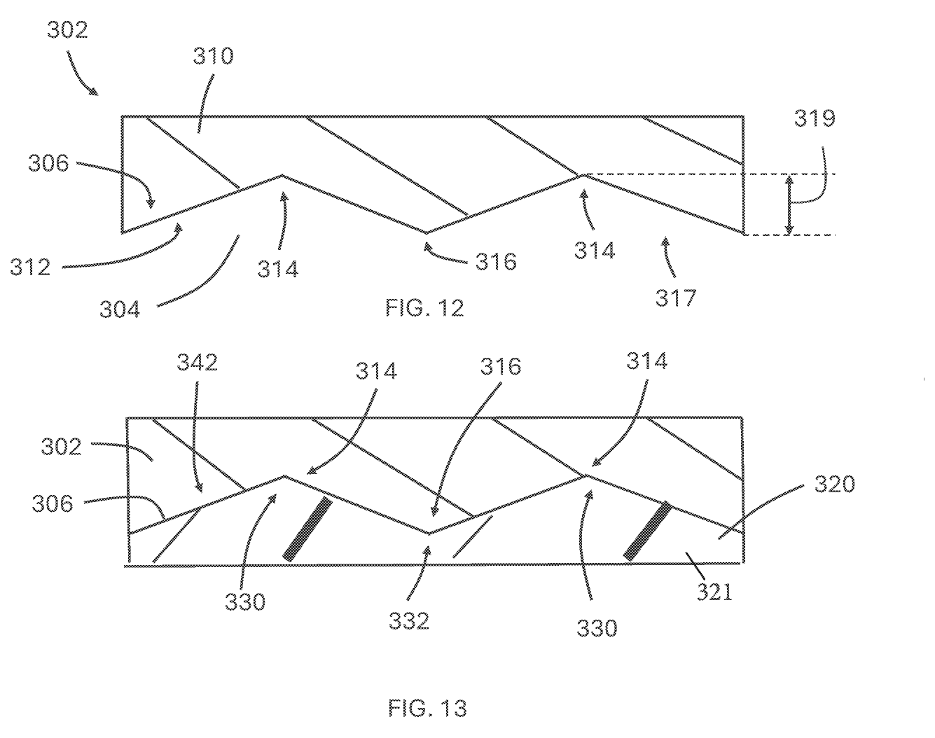

Regarding FIGS. 11-16, a method 300 is provided for making furniture 308 having a surface texture. The furniture may be the bed body 12 discussed above, or may be a table, nightstand, or bookshelf as some examples. The method 300 utilizes a mold 302 to rotationally mold the furniture 308. The mold 302 has a mold cavity 304 configured to form the shape of the furniture 308. The furniture 308 has a one-piece plastic body 321 that is directly formed by the features of the mold 302. For clarity purposes, portions of the mold 302 and furniture 308 are shown in FIGS. 12-16, rather than the entire mold 302 and furniture 308.

With reference to FIG. 12, the mold 302 has interior surfaces 306 configured to form the exterior surfaces of the furniture 308. The mold 302 includes a die 310 with an engraved portion 312 defining a texture. The engraved portion 312 may be made by laser etching the die 310. The die 310 is made of a metallic material, such as aluminum. The engraved portion 312 has a texture, such as a woodgrain texture, desired to be present in the furniture. Other textures may be used, such as a brick or stone texture. The engraved portion 312 includes valleys 314 and peaks 316. Although the valleys and peaks 314, 316 are shown as straight lines with points, it will be appreciated that the valleys and peaks 314, 316 have different configurations, such as curved, sinusoidal, or jagged profiles as desired. In one embodiment, the engraved portion 312 has recesses 317 with a uniform depth 319 throughout a majority, such as 60%, 70%, 80%, 90%, or 100%, of the surface area of the engraved portion 312.

Regarding FIGS. 11 and 13, the method 300 at step 301 includes rotationally molding the furniture using the mold 302. The step 301 includes advancing the molding material, such as plastic granules, into the mold cavity 304, heating the mold 302, and rotating the mold 302 to evenly coat the interior surfaces 306 with the plastic material. The step 301 may include applying a rotational molding release agent to the mold 302 prior to advancing the molding material into the mold cavity 304, such as spraying a rotational molding release agent on the interior surfaces 306. The step 301 may also include venting hot air from within the mold 302 during the rotational molding process, to ensure consistent molding tolerances.

The rotational molding of step 301 forms a texture portion 320 (see FIG. 13) of the plastic body 321 of the furniture 308 in direct contact with the engraved portion 312 of the mold 302. The texture portion 320 of the furniture 308 has the inverse of the texture of the engraved portion 312 of the mold die 310. More specifically, the texture portion 320 of the furniture 308 has a peak 330 at a valley 314 of the die 310 and a valley 332 of the furniture 308 at the peak 316 of the die 310. The peaks 330 of the furniture 308 are outer portions of ridges 333 of the body 321.

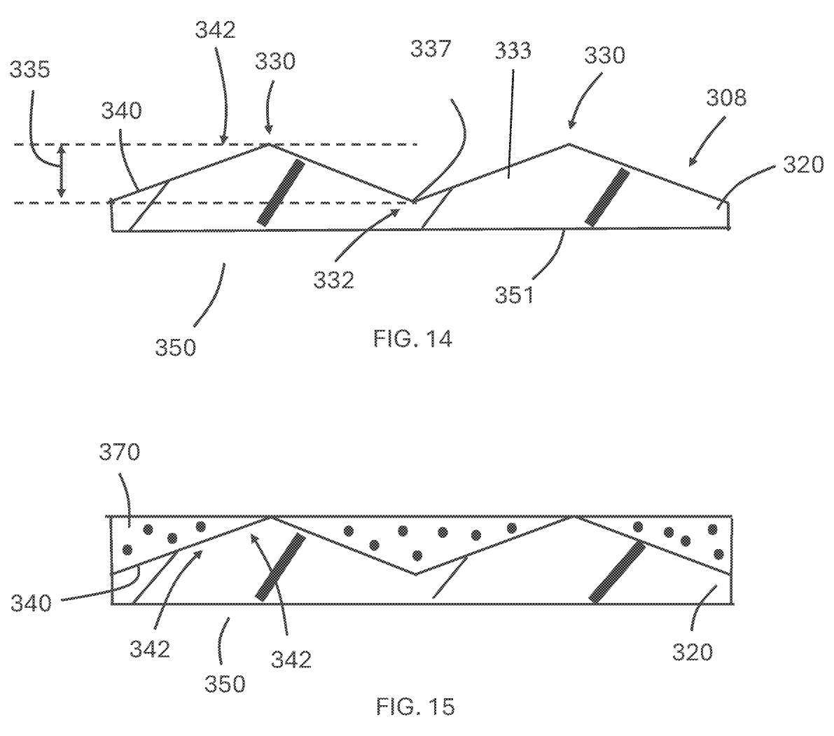

Regarding FIG. 14, in one embodiment, the peak 330 has a height 335 above a lowermost portion 337 of the valley 332. The peaks 330 and valleys 314 may have a variety of shapes, such as jagged peaks/valleys; rounded peaks/valleys; valleys with different widths, lengths and/or depths; peaks with different widths, lengths, and/or heights, or a combination thereof as a few examples.

Regarding FIGS. 11 and 14, the method 300 includes removing 303 the rotationally molded furniture 308 from the mold. In FIG. 14, the furniture texture portion 320 is shown removed from the mold cavity 304 and has an outer or exterior surface 340 with a texture 342 formed by the engraved portion 312 of the mold 302. The furniture 308 has an interior 350 with a smooth inner or interior surface 351. For example, the furniture 308 may be the bed body 12, the interior 350 may be the interior 130, and the texture 342 may be the woodgrain texture on the exterior of the intermediate panel 52 of one of the side walls 34.

Regarding FIGS. 11 and 15, step 305 of the method 300 includes applying a colorant 370 to the texture 342 on the exterior surface 340 of the furniture 308. The colorant 370 operates as a stain that bonds with the plastic exterior surface 340 of the furniture 308.

The colorant 370 may include, for example, ink and a delivery agent. For example, the colorant 370 includes one or more pigments to provide a desired color for the woodgrain texture of the furniture, taking into account the color of the plastic used to form the furniture at step 301. As an example, the colorant 370 may include an inorganic pigment with a carrier resin.

The step 305 may include spraying, pouring, or wiping the colorant 370 onto the texture 342 of the furniture 308. For example, a worker may wipe the colorant 370 onto the exterior surface 340 of the furniture 308.

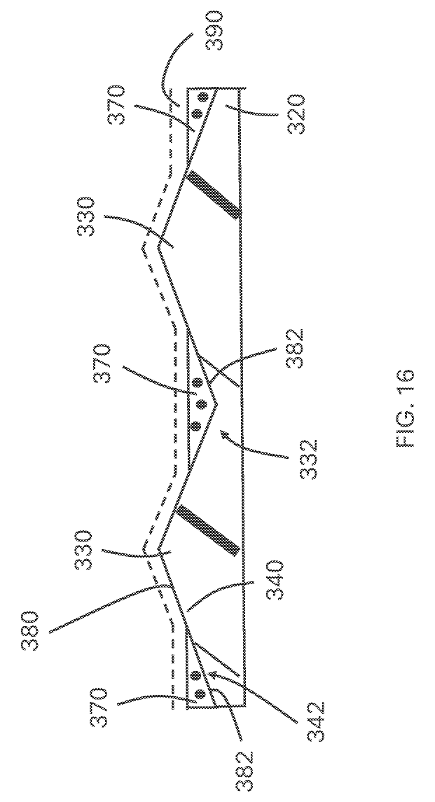

Regarding FIGS. 11 and 16, step 307 of the method 300 includes removing excess colorant 370 from the exterior surface 340 of the furniture 308. More specifically, step 307 includes removing the colorant 370 from a portion of the furniture texture 342 to provide exposed portions 380 of the woodgrain texture 342 wherein the exterior surface 340 has a reduced thickness of the colorant 370, such as no colorant. The step 307 includes leaving colorant 370 on covered portions 382 of the woodgrain texture 342. For example, the step 307 may include removing the colorant 370 from the peaks 330 of the texture 342 while leaving colorant in the valleys 332 of the texture 342. The step 307 may include a worker wiping off the colorant 370 from the peaks 330 using a cloth, for example.

The step 307 may be performed a predetermined period of time after step 305 to give the colorant 370 time to color the exterior surface 340 and settle in the valleys 332 of the texture 342. For example, the step 307 may be performed 30 seconds after or up to 30 minutes after step 305.

In one embodiment, the material of the furniture texture portion 320 has a first color and the colorant 370 has a different second color. For example, the second color of the colorant 370 may be darker than the first color of the material of the furniture texture portion 320. In this manner, the colorant 370 makes the texture 342 more pronounced and visible to a user. Further, because the darker colorant 370 is at the bottom of the valleys 332, the darker colorant 370 provides a visually greater depth of the texture 342 on the exterior surface 340 of the furniture 308.

Regarding FIG. 11, the method 300 may include applying multiple layers of colorant to achieve a desired appearance of the woodgrain texture of the surface of the furniture. At step 309, the method 300 includes determining whether the colorant application and removal steps 305, 307 have provided a desired appearance of the woodgrain texture. The desired appearance may include the woodgrain having desired colors, the woodgrain texture having a predetermined level of visual contrast between colors of the grain, etc. The determination at step 309 may be determined visually by an individual. Alternatively or additionally, an optical sensor (e.g. a camera) may be used to compare the appearance of the woodgrain texture to the desired appearance.

If the desired appearance has not been achieved at step 309, the method 300 returns to step 305 and another application of colorant is performed at step 305 and a portion of the colorant is removed from the texture at step 307. The steps 305, 307 are repeated until the woodgrain texture has the desired appearance at step 309.

The colorant applied at the first time the method 300 reaches step 305 may be different than the colorant applied at the second time, third time, etc. the method 300 reaches step 305. For example, the method 300 may involve applying a first colorant with a first color the first time the method 300 reaches step 305 and the method 300 may involve applying a different, second colorant having a second color the second time the method 300 reaches step 305.

Once the woodgrain texture of the surface of the furniture has the desired appearance, the method 300 proceeds to optional step 311 wherein an outer layer 390 may be to seal or otherwise protect the furniture 308. The outer layer 390 may be transparent.

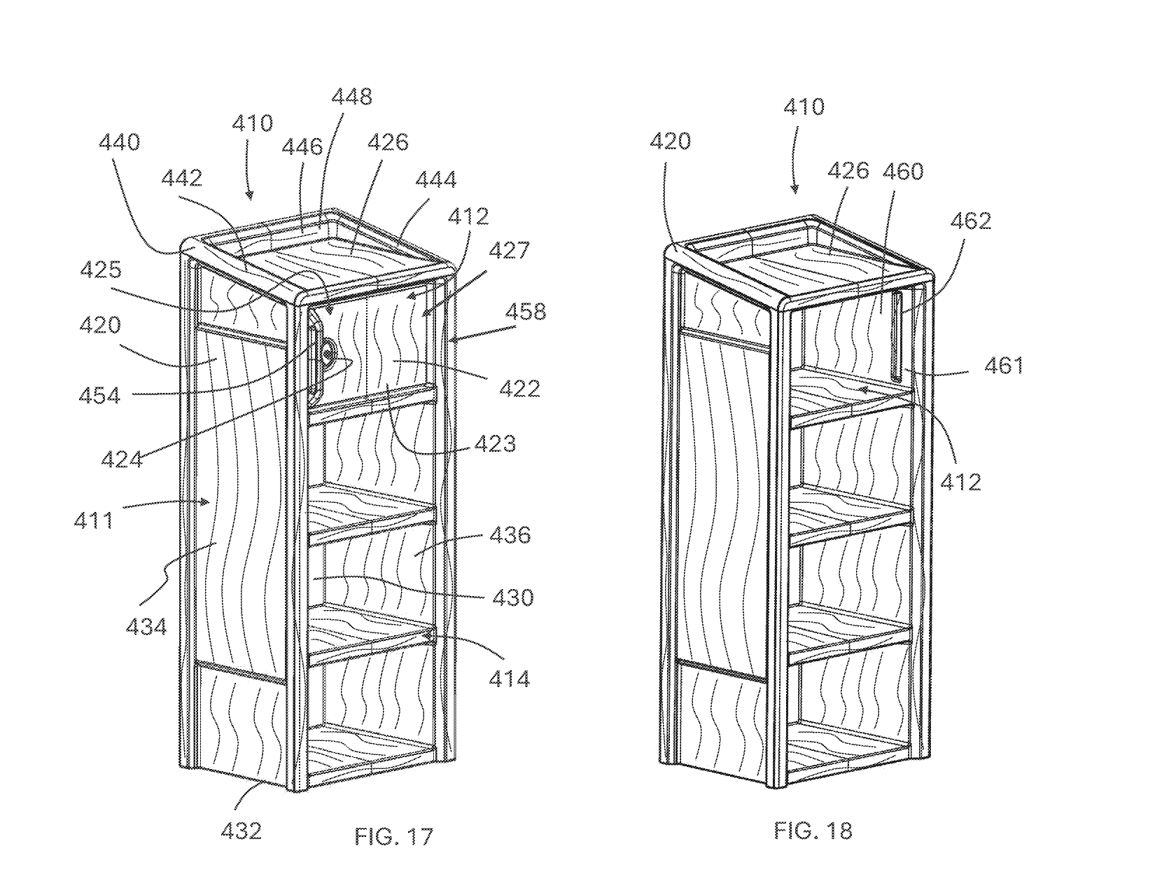

Regarding FIG. 17, a cabinet 410 is provided having outer surfaces 411 with a woodgrain texture. The cabinet 410 may be formed using the method 300 of FIGS. 11-16. The cabinet 410 has a lockable compartment 412 and one or more shelves 414 for receiving personal items. The cabinet 410 includes a body 420 that may be rotationally molded and a door 422 with a lock 424. The door 422 can be removed or disconnected from the body 420 and placed on an upper shelf 426 of the body 420 once the lock 424 has been unlocked. The door 422 is connected to the body 420 without the use of a metal hinge between the door 422 and the body 420.

The lock 424 may be unlocked and the door 422 disconnected from the body 420 by, for example, a nurse providing a patient once-daily access to the compartment 412. The nurse may place the disconnected door 422 upon the upper shelf 426 while the patient accesses the compartment 412. Once the patient is done accessing the compartment 412, the nurse reconnects the door 422 to the body 420 and locks the lock 424.

The body 420 has a rear wall 430 that may be secured, such as with fasteners, to a wall of a room. The body 420 includes a bottom portion 432 that may rest on a floor of the room. The bottom portion 432 may be secured, such as with fasteners, to the floor.

The body 420 further includes opposite sides 434, 436 and has the shelves 414 extending therebetween. The body 420 has outer surfaces 440 that are free of openings, sharp corners, or other features that may provide tie-off points. In this manner, the cabinet 410 is ligature-resistant.

At the upper end of the cabinet 410, the body 420 includes inclined walls 442, 444 and a rear wall 446 extending therebetween that define a recess 448 above the upper shelf 426 to receive the door 422. The upper shelf 426 may also provide a horizontal surface for supporting items.

The inclined walls 442, 444 provide a smooth transition from the upper shelf 426 to the rear wall 446 that is free of sharp edges or other tie-off points to enhance ligature resistance.

The door 422 has a body 423 that supports the lock 424 and may be made of plastic, such as rotationally molded or injection-molded plastic. The body 423 may be solid to provide rigidity to the door 422. The body 423 may have a unitary, one-piece construction. The door 422 has opposite end portions 425, 427 for engaging portions of the body 420 on opposite sides of the compartment 412. The end portion 425 includes the lock 424 and a handle 454 that may be grasped by a user to remove the door 422 once the lock 424 has been unlocked.

The end portion 427 of the door 422 and a portion of the body 420 engage to form a tongue-and-groove hinge 458 of the compartment 412. The tongue-and-groove hinge 458 permits the door 422 to pivot outwardly and be removed from the body 420 to open the compartment 412 after the lock 424 has been unlocked. Conversely, the user may connect the tongue-and-groove hinge 458 and swing or pivot the door 422 inwardly to close the compartment 412 before locking the lock 424. The tongue-and-groove hinge 458 permits opening and closing of the door 422 without a separate metallic hinge.

Regarding FIG. 18, the cabinet 410 is shown with the door 422 removed. The compartment 412 has an interior 460 that is accessible once the door 422 has been removed. The compartment 412 has an inner wall 461 with a hinge recess 462 that forms a part of the tongue-and-groove hinge 458.

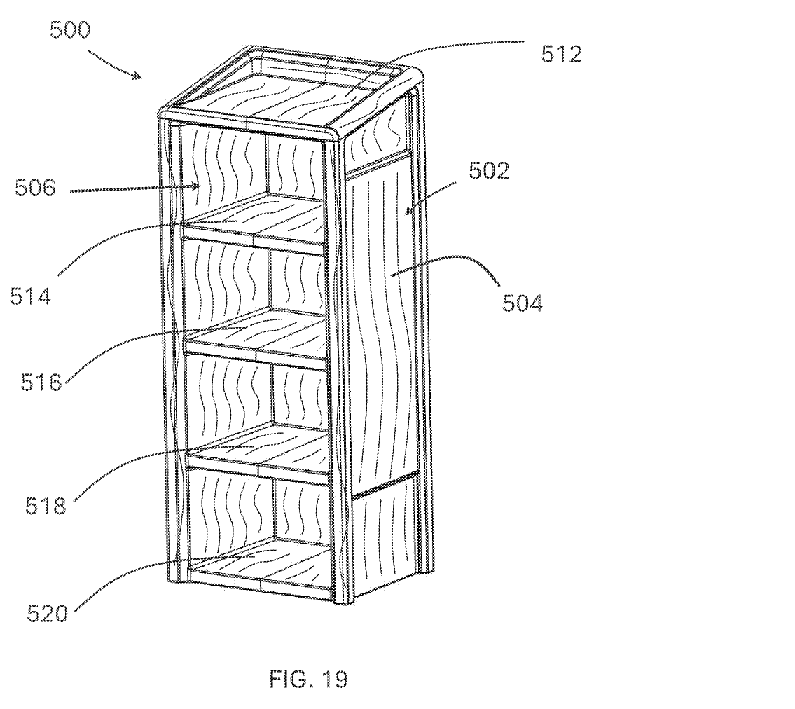

Regarding FIG. 19, a cabinet 500 is provided that is similar in many respects to the cabinet 410 discussed above. The cabinet 500 includes outer surfaces 502 with a woodgrain texture. The cabinet 500 may be formed using the method 300 of FIGS. 11-16.

The cabinet 500 includes a body 504 that may be rotationally molded. The body 504 includes a compartment 506. Unlike the compartment 412, the compartment 506 does not include a lockable door. The body 504 further includes shelves 512, 514, 516, 518, 520 for receiving items.

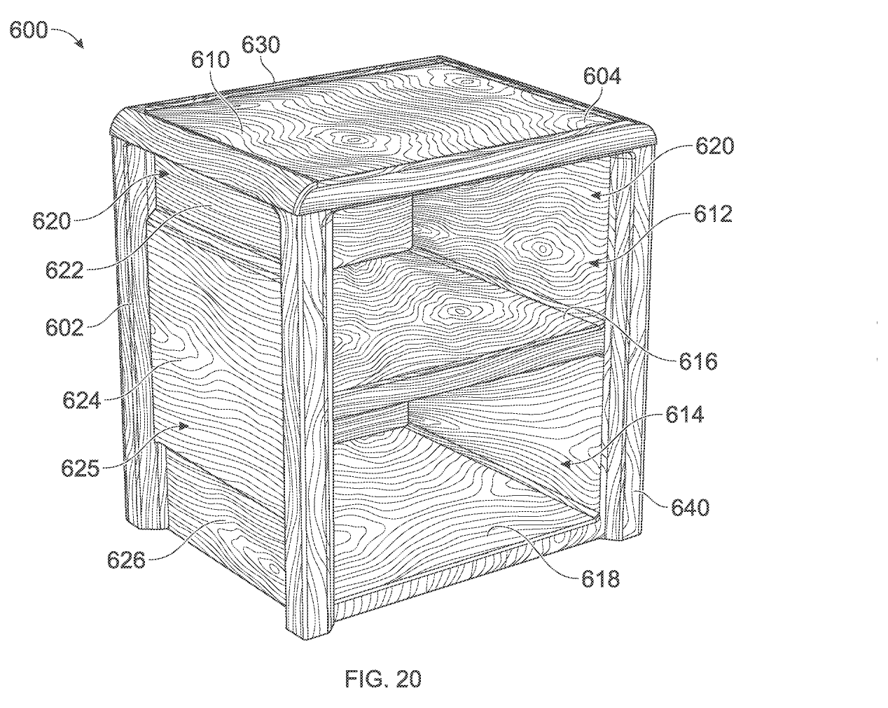

With reference to FIG. 20, a nightstand 600 is provided that may be formed using the method 300 of FIGS. 11-16. The nightstand 600 has a body 602 that is made of a rotationally molded plastic and includes outer surfaces 604 having a woodgrain texture. In one embodiment, the nightstand body 602 has a unitary, one piece construction. The nightstand body 602 has an interior that may be empty or may contain structural foam, as some examples.

The nightstand 600 includes a top surface 610 and compartments 612, 614 with shelves 616, 618. The nightstand 600 includes opposite side walls 620 with exterior portions 625 that each include an upper panel 622, an intermediate panel 624, and a lower panel 626 with varying insets. The varying insets of the panels 622, 624, 626 creates a structured cross-section (taken normal to the side 620) of the side wall exterior portion 625 which strengthens the side walls 620.

The nightstand 600 includes a rear wall 630 that may have an exterior portion with a structured cross-section similar to the side wall exterior portions 625. The nightstand 600 includes posts 640 at corners of the nightstand 600 to further strengthen the nightstand 600.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

While there have been illustrated and described particular embodiments of the present invention, it will be appreciated that numerous changes and modifications will occur to those skilled in the art, and it is intended for the present invention to cover all those changes and modifications which fall within the scope of the appended claims.

What is claimed is:

1. A method of making rotationally molded furniture with a woodgrain texture, the method comprising:
rotationally molding furniture using a mold having the woodgrain texture;
removing the rotationally molded furniture from mold, the rotationally molded furniture having the woodgrain texture;
applying a colorant to the woodgrain texture of the rotationally molded furniture; and
removing the colorant from a portion of the woodgrain texture of the rotationally molded furniture.

2. The method of claim 1 wherein applying the colorant to the woodgrain texture comprises applying the colorant to the woodgrain texture outside of the mold.

3. The method of claim 1 wherein the woodgrain texture of the mold comprises a plurality of different woodgrain textures; and
wherein rotationally molding the furniture includes rotationally molding the furniture to include the plurality of different woodgrain textures.

4. The method of claim 1 wherein the furniture includes panels;
wherein the woodgrain texture comprises a plurality of different woodgrain textures; and
wherein rotationally molding the furniture includes rotationally molding the panels to include the plurality of different woodgrain textures.

5. The method of claim 1 wherein removing the colorant comprises removing colorant from peaks of the woodgrain texture and leaving colorant in valleys of the woodgrain texture.

6. The method of claim 1 wherein removing the colorant comprises wiping the woodgrain texture of the rotationally molded furniture to remove colorant from raised portions of the woodgrain texture while leaving colorant in recesses of the woodgrain texture.

7. The method of claim 1 wherein the woodgrain texture of the mold comprises a laser engraved woodgrain texture in a metallic mold portion.

8. The method of claim 1 wherein rotationally molding the furniture includes advancing a plastic material having a first color into the mold; and
wherein the colorant has a second color that is darker or lighter than the first color.

9. The method of claim 1 wherein the colorant has a first color, the method further comprising:
after removing the colorant from the portion of the woodgrain texture:
applying another colorant having a different, second color to the woodgrain texture of the rotationally molded furniture; and
removing the colorant having the second color from a portion of the woodgrain texture of the rotationally molded furniture.

10. The method of claim 1 further comprising applying an outer layer to the woodgrain texture of the rotationally molded furniture after removing the colorant from the portion of the woodgrain texture.

11. The method of claim 1 wherein the furniture comprises a bed, a cabinet, or a nightstand.

12. The method of claim 1 wherein rotationally molding the furniture includes advancing plastic molding material into a cavity of a mold having an inner surface with the woodgrain texture.

13. The method of claim 12 further comprising:
applying a mold release agent to the woodgrain texture of the mold before advancing the plastic molding material into the cavity of the mold.

14. The method of claim 1 wherein rotationally molding the furniture includes molding a plastic body of the furniture, the body having a unitary, one-piece construction.

15. Furniture comprising:
a body made of rotationally molded plastic having a first color, the body having a unitary, one-piece construction;
an outer surface of the rotationally molded plastic body having a woodgrain texture, the woodgrain texture including a plurality of ridges and a plurality of valleys intermediate the ridges, the ridges including peaks spaced outwardly away from the valleys;
a colorant on the woodgrain texture of the rotationally molded plastic body, the colorant having a second color different than the first color of the rotationally molded plastic body;
the colorant including portions in the valleys of the woodgrain texture; and
the peaks of the ridges having less colorant thereon than the valleys to permit the first color of the peaks to be visible adjacent the second color of the colorant in the valleys.

16. The furniture of claim 15 wherein the peaks of the ridges have no colorant thereon.

17. The furniture of claim 15 wherein the second color is darker than the first color.

18. The furniture of claim 15 wherein the body includes a wall including the outer surface, the wall including a first wall portion and a second wall portion; and
wherein the woodgrain texture includes a first woodgrain texture of the first wall portion and a different, second woodgrain texture of the second wall portion.

19. The furniture of claim 15 wherein the rotationally molded plastic body includes a hollow interior;
wherein the body includes an outer wall including the woodgrain texture and an inner surface opposite the woodgrain texture; and
wherein the inner surface defines at least a portion of the hollow interior of the rotationally molded plastic body.

20. The furniture of claim 15 wherein the rotationally molded plastic body includes an empty, hollow interior.
